(19) United States
(12) Patent Application Publication
(10) Pub. No.: US 2024/0168785 A1
(43) Pub. Date: May 23, 2024

(54) REMOTE DESKTOP COMPOSITION

(71) Applicant: ATI TECHNOLOGIES ULC, MARKHAM (CA)

(72) Inventor: Jeffrey G. Cheng, Markham (CA)

(21) Appl. No.: 17/992,533

(22) Filed: Nov. 22, 2022

(51) Int. Cl. G06F 9/455

(52) U.S. Cl. CPC G06F 9/45545

(57) ABSTRACT

In response to a notification from one or more virtual machines, a host with access to a physical function of a virtualized display device utilizes the physical function to directly access a frame memory of the virtualized display device associated with the notifying virtual machine(s). The host generates a composited frame for display, via the virtualized display device or otherwise, by selecting rendered frames from one or more of the notifying virtual machines.

### BACKGROUND

The present disclosure relates to the capture and selective display of rendered graphical frames and/or other audiovisual content using remote desktop composition. Previous solutions for such capture and selective display are often associated with high latency operations that involve the copy and transfer of selected frames.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a local virtualized server configuration for remote desktop composition in accordance with some embodiments.

FIG. 2 is an operational flow diagram illustrating an example of a routine for performance by a server computing system suitable for implementing one or more embodiments.

FIG. 3 is a component-level block diagram illustrating an example of a server computing system suitable for implementing one or more embodiments.

### DETAILED DESCRIPTION

The single root I/O virtualization (SR-IOV) interface is an extension to the Peripheral Component Interconnect Express (PCI Express or PCIe) serial computer expansion bus specification that allows a device, such as a network adapter or display adapter, to provision segregated access to its resources among various PCIe hardware functions. These functions include both physical functions (PFs), which directly comprise primary functions of the hardware device and which typically require system- or supervisory-level permissions to access; and virtual functions (VFs), which are associated with the hardware device's PF but which utilize a virtualized version of one or more physical resources of the device (e.g., memory, display adapter, network port, etc.).

Embodiments described herein provide a low-latency manner by which rendered frames from multiple source applications may be composited and/or selected. In some embodiments, a host virtual machine directly accesses frame memory of a virtual function associated with each of one or more virtual machines that are communicatively coupled to, or executing on, a server computing system. The virtual function enables access to a virtualized display device such that a host virtual machine executing on the server computing system may leverage a physical function of the virtualized display device to directly access the frame memory of one or more associated virtual functions for low-latency retrieval and display.

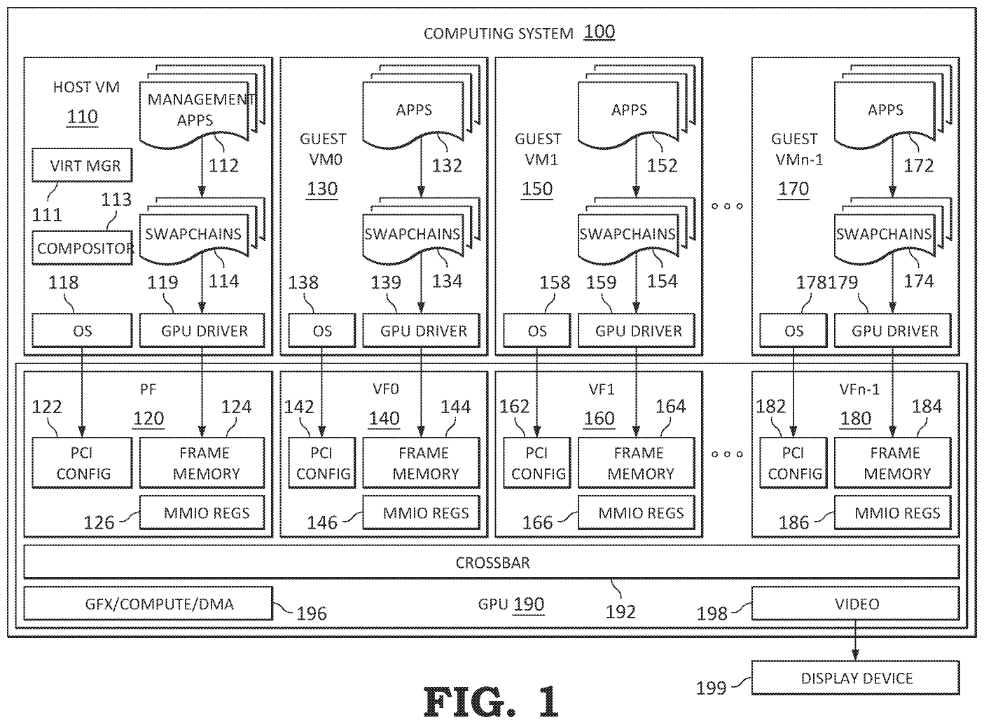

FIG. 1 illustrates a local virtualized server configuration for remote desktop composition in accordance with some embodiments. In particular, in the depicted embodiment a computing system 100 is executing a host VM 110 along with a plurality of guest VMs 130, 150, 170. The host VM 110 includes a virtualization manager 111 that performs various VM management functions with respect to the guest VMs 130, 150, 170, and is also executing a compositor 113 to generate composited frames for display based on individual rendered frames received as input, such as from one or more applications 112 executed by the host VM 110, or by one or more applications 132, 152, 172 respectively executed by guest VMs 130, 150, 170, as discussed in greater detail below. It will be appreciated that in various embodiments, guest VMs 130, 150, 170 may represent any quantity n of guest VMs (e.g., guest VMs 0, 1, . . . , n-1).

Each of the host VM 110 and guest VMs 130, 150, 170 is communicatively coupled to a virtualized physical display device (virtualized physical display) 199 via physical or virtual functions representing physical hardware functionality of the virtualized physical display device 199 (e.g., a monitor or other display screen) and supported by a graphics processing unit (GPU) 190 of the computing system 100. In particular, the host VM 110 is communicatively coupled to the virtualized physical display 199 via a physical function 120; each of the guest VMs 130, 150, 170 is communicatively coupled to the virtualized physical display 199 via a respective GPU driver 139, 159, . . . , 179, each of which utilizes a respective virtual function 140 (VF 0), 160 (VF 1), 180 (VF n-1) to access functionality provided by the virtualized physical display 199.

It will be appreciated that in certain embodiments and scenarios, the computing system 100 may be a server computing system with no attached physical display device, such that operations described herein with respect to frames intended for display via the virtualized physical display 199 are performed such that those frames are output via one or more network connections to one or more client devices for localized display.

While various embodiments may operate in various scenarios, for purposes of this example, the local virtualized server configuration of the depicted embodiment can be considered to operate as a head unit (a control and display management system) of a vehicle, such that the host VM 110 and the guest VMs 130, 150, 170 are all co-located on (and executed by) the computing system 100. In this scenario, each of the guest VMs 130, 150, 170 is responsible for running one or more applications as individual subsystems of vehicle configuration and control. For example, guest VM 130 operates an entertainment subsystem (via applications 132) to control and display information regarding music, video, and other audiovisual entertainment selected by a user of computing system 100; guest VM 150 operates (via applications 152) seating and environment controls; and guest VM 170 operates (via applications 172) an engine tuning and diagnostics subsystem. Such utilization of the computing system 100 is merely exemplary, and it will be appreciated that embodiments described herein may operate in a wide variety of contexts and scenarios.

In operation, each of the guest VMs 130, 150, 170 is respectively responsible for generating content via applications 132, 152, 172, for rendering frames of that content for display on the virtualized physical display 199, and for storing (via its respective GPU driver 139, 159, 179) the rendered frames in a respective frame memory 144, 164, 184 associated with the guest VM's respective virtual function 140, 160, 180. The host VM 110 is responsible for generating composited frames for presentation, such as via the virtualized physical display 199. In particular, the host VM 110 retrieves rendered frames from one or more of the guest VMs 130, 150, 170 to selectively provide composited frames that may include at least a portion of one or more of those retrieved rendered frames. For example, to continue the example of the vehicle head unit, the host VM 110 may determine during regular driving operations to display in full each rendered frame of the entertainment subsystem retrieved from guest VM 130. Under various scenarios and circumstances, the host VM 110 may determine to generate composited frames for display using the entirety of one or more rendered frames from one guest VM (e.g., to present full rendered frames of the seating and environment control subsystem rendered by guest VM 150), or to generate such composited frames using only a portion of rendered frames retrieved from two or more of guest VMs 130, 150, 170 in order to present information for multiple such subsystems simultaneously. The host VM 110 utilizes compositor 113 to generate composited frames for display based on one or more rendered frames retrieved from one or more of guest VMs 130, 150, 170.

The host VM 110 generally operates as a privileged system management partition of the computing system 100. In certain embodiments, the primary responsibility of the host VM 110 is to manage the computing system 100, including to act as a hypervisor (via virtualization manager 111) over the guest VMs (e.g., initiating instantiation, suspension, and/or destruction of guest VMs, guest VM workload scheduling, and the like). Additionally, in some embodiments the host VM 110 is responsible via virtualization manager 111 for various operations with respect to the abstraction and virtualization of hardware resources associated with the computing system 100, such as the virtualized physical display 199.

In the depicted embodiment, the virtualized physical display 199 is associated with physical and virtual functions that allow VMs executing on (or otherwise privileged by) the computing system 100 to access and invoke hardware functionality associated with the virtualized physical display 199 (or to otherwise display one or more rendered or composited frames). The virtualized physical display 199 is associated with virtual functions 140, 160, 180 (VF0, VF1, . . . , VFn-1, respectively) of the display hardware for use by the respective guest VMs 130, 150, 170; the host VM 110 enjoys privileged access to the virtualized physical display 199 via the physical function (PF) 120, which directly accesses hardware functionality of the virtualized physical display 199 via the host VM GPU driver 119. Each of physical function 120 and virtual functions 140, 160, 180 is respectively associated with a PCI configuration block 122, 142, 162, 182; a frame memory 124, 144, 164, 184; and a set of memory-mapped I/O (MMIO) registers 126, 146, 166, 186. Frame memories 124, 144, 164, 184 are frame buffers for the storage of rendered frames intended by their respective VM for presentation on the virtualized physical display 199.

The host VM 110 is associated with a set of escalated privileges, not enjoyed by the managed guest VMs 130, 150, 170, that includes both retrieving a rendered frame directly from the virtualized display memory (frame memories 144, 164, 184) of those guest VMs' respective virtual functions, as well as accessing physical function 120 (and its frame memory 124) for displaying the composited frame. In contrast, each guest VM 130, 150, 170 is associated with a set of privileges that does not include access to the physical function 120 or to the frame memories associated with other guest VMs. In contrast, the PF 120 includes a superset of the functionality offered by the VFs 140, 160, 180, including being able to access the frame memories 144, 164, 184 that are respectively associated with guest VMs 130, 150, 170. In general, the PF 120 and VFs 140, 160, 180 are each assigned a unique requester identifier (RID) that allows an I/O memory management unit (IOMMU) to differentiate between different traffic streams and apply memory and interrupt translations between the PF 120 and VFs 140, 160, 180. This allows traffic to be delivered directly to the appropriate host VM or guest VM, such as to deliver nonprivileged data traffic from the host VM 110 to one of the guest VMs 130, 150, 170 without affecting the others.

In operation, and with specific reference to operations of the guest VM 130, suppose that an application 132 generates a frame of content for display. The application 132 presents the generated frame for display by storing the generated frame in swap chain 134. A swap chain is a series (typically application-specific, such that each application 132 maintains a corresponding swap chain 134) of real or virtualized frame buffers that are used for displaying graphical frames to a user, such that each time an application presents a new frame for display, the next frame buffer in the swap chain takes the place of the currently displayed frame buffer. In various embodiments and scenarios, each of the swap chains 134 may contain frames rendered based on content from a particular application, or that form an entire composited multi-application desktop of the guest VM 130. With respect to the host VM 110, swap chains 114 may contain frames rendered based on content from a particular application 112, or that form an entire composited multi-application desktop of the host VM 110. In addition, the swap chains 114 of the host VM 110 may include generated frames from any of the swap chains 134, 154, 174 of the respective guest VM's 130, 150, 170.

When the application 132 stores a new generated frame in a frame buffer of the swap chain 134, it notifies the GPU driver 139, which transfers the generated frame to be displayed into frame memory 144 via virtual function 140. In certain embodiments and scenarios, the guest VM 130 may determine to generate rendered frames for display via the virtual function 140 by generating a composite frame that includes portions of frames rendered by multiple applications 132 and stored in multiple of the corresponding swap chains 134. In such a scenario, a compositor facility of OS 138 generates and stores the composited frame in frame memory 144, rather than a single generated frame from one application 132. In either case, when the guest VM 130 renders and stores a rendered frame in frame memory 144, that rendered frame can be directly accessed and read by the host VM via the PF 120.

Continuing the example with respect to operations of the guest VM 130, when the GPU driver on the guest VM is notified to present a rendered frame for display (e.g., responsive to a frame buffer of one of the swap chains 134 being modified), it notifies the GPU driver 119 of the host VM 110 that the rendered frame is available from the guest VM 130. In certain embodiments, this communication is facilitated by mailbox facilities of the SR-IOV interface. In particular, in such embodiments the GPU driver 139 sets a mailbox register (not shown) of the VF 140. That write operation of the mailbox register triggers an interrupt on the host VM 110, which is processed by the host GPU driver 119 to determine which guest VM has written to the mailbox register (and therefore which guest VM has a rendered frame available for display). Upon identifying guest VM 130, the host GPU driver 119 accesses the frame memory 144 and retrieves the rendered frame prepared by guest VM 130 via its applications 132, swap chains 134, and GPU driver 139. In certain embodiments, retrieving the generated frame from frame memory 144 in a low-latency manner may include setting a pointer value for the host VM's frame memory 124 to a memory address of the accessed frame memory 144 of the guest VM 130.

Once the host VM 110 has retrieved the generated frame from frame memory 144 (either by copying its contents or redirecting a pointer value accordingly), the host VM 110 generates a composited frame for display based on the rendered frame from the guest VM 130. As noted above, in various scenarios and circumstances, the host VM 110 may determine to generate composited frames for display using the entirety of the rendered frame from the guest VM 130, or to generate such composited frames using only a portion of that rendered frame along with portions of similarly rendered frames retrieved from one or more of guest VMs 150, 170 in order to simultaneously present information from multiple of the guest VMs. The host VM 110 utilizes compositor 113 to generate composited frames for display based on one or more rendered frames retrieved from one or more of guest VMs 130, 150, 170. In various embodiments, the compositor 113 may be one or more of a group that includes a software compositor executable by the host VM 110; a component of an operating system (OS) 118 of the host VM 110; a hardware compositor of the GPU 190 and controlled by the host VM 110 via the GPU driver 119; or some combination of one or more of these.

It will be appreciated that although specific operations above are described with respect to guest VM 130 and its various associated elements, similar operations are performed by each of the guest VMs 150, 170 and their respectively associated elements as well.

Each of the host VM 110 and guest VMs 130, 150, 170 is executing a respective operating system (OS) 118, 138, 158, 178. In various embodiments, each OS 118, 138, 158, 178 may be substantially identical or may be distinct, such that each VM operates via a distinct OS that is independent of that executed on the other VMs. In addition, each of the host VM 110 and guest VMs 130, 150, 170 include a respective GPU driver 119, 139, 159, 179, which is communicatively coupled to the virtualized physical display 199 via physical function 120 or virtual functions 140, 160, 180.

In the depicted embodiment, the GPU 190 further includes a communication cross bar 192, which provides cross-communication for components of the GPU 190. In the depicted embodiment, the GPU 190 further includes functional blocks 196 (e.g., fixed function blocks, compute blocks, direct memory access (DMA) control blocks, etc.), and a video interface 198, which communicatively couples the virtualized physical display 199 to the computing system 100.

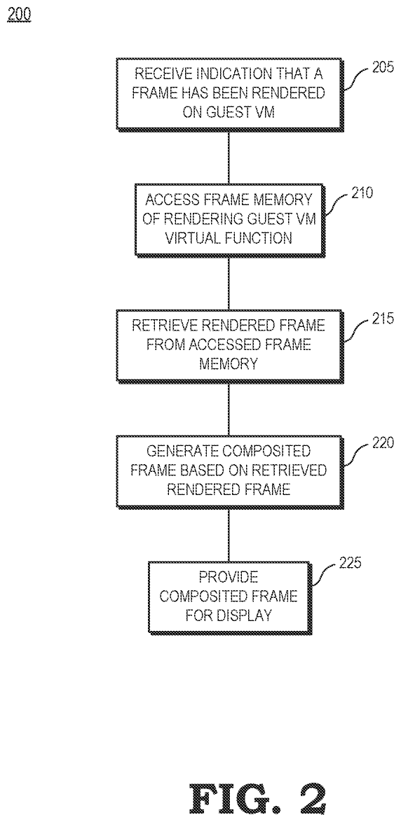

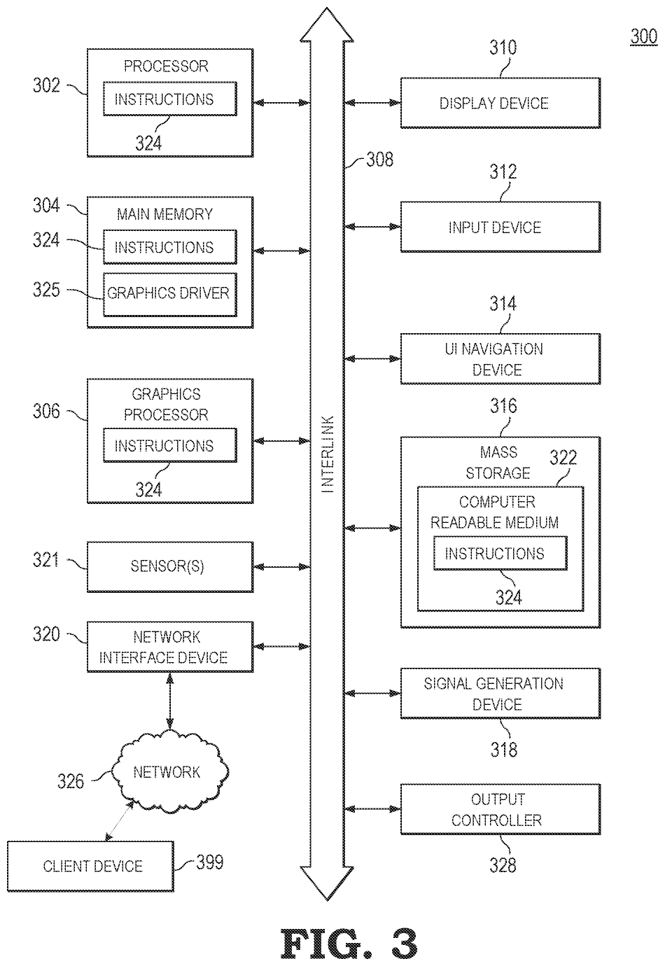

FIG. 2 is a flow diagram illustrating an example of an operational routine 200 for performance by a server (such as computing system 100 of FIG. 1 or server computing system 300 of FIG. 3, described below). In particular, in some embodiments the operational routine is substantially performed by instructions (e.g., as at least some of instructions 324 of FIG. 3) executed by one or more hardware processors of the server (e.g., hardware processor 302 of FIG. 3) and associated with one or more virtual machines (e.g., host VM 110 and guest VMs 130, 150, 170 of FIG. 1) executing on the server.

The operational routine begins at block 205, in which a host virtual machine (e.g., host VM 110 of FIG. 1) receives an indication that a new frame has been rendered by a specified guest VM and is available for display. In certain embodiments, the indication includes a notification triggered by one or more modifications to a frame buffer of a swap chain that is associated with an application executing on the specified guest VM. In certain scenarios and embodiments, the rendering guest VM is one of one or more guest VMs managed by the host VM, such as may be executing on the same server. The operational routine proceeds to block 210.

At block 210, the host VM accesses a frame memory associated with the rendering guest VM. In certain embodiments, the frame memory is associated with a virtual function of the rendering guest VM, such as to provide the rendered frame to a virtualized display device. In certain embodiments, accessing the frame memory is performed as part of processing an interrupt generated by a register (such as a mailbox register) being set. The routine proceeds to block 215, in which the host VM retrieves the available rendered frame from the accessed frame memory, and then to block 220.

At block 220, the host VM generates a composited frame for display based at least in part on the rendered frame retrieved from the guest VM's accessed frame memory. In certain embodiments, generating the composited frame is performed by a compositor facility (e.g., compositor 113 of FIG. 1) or operating system (e.g., OS 118) of the host VM. As discussed elsewhere herein, the composited frame may include portions generated by a single application executing on a single guest VM, by multiple applications executing on a single guest VM (such as may have been composited by the guest VM as part of rendering the frame that was retrieved in block 215), or by compositing portions of multiple rendered frames retrieved from multiple guest VMs (and generated by one or more applications executed thereby) for simultaneous display. The operational routine proceeds to block 225.

At block 225, the host machine provides the composited frame for display. In certain embodiments and scenarios, the host VM provides the composited frame for local display using a physical function of a GPU of the server (e.g., GPU 190 of FIG. 1 or GPU 306 of FIG. 3), such as via a video interface of the GPU (e.g., video interface 198 of FIG. 1) and a coupled display (e.g., virtualized physical display 199). In certain embodiments, providing the composited frame for display includes providing (e.g., streaming, such as to provide a series of such composited frames in substantially real time over a network, such as via network interface device 320 and communications network 326 of FIG. 3 below) it to a remote client device (e.g., client device(s) 399) for presentation via a communicatively coupled display device.

FIG. 3 is a component-level block diagram illustrating an example of a server computing system 300 suitable for implementing one or more embodiments. In alternative embodiments, the server computing system 300 may operate as a standalone device or may be connected (e.g., networked) to other systems. In various embodiments, one or more components of the server computing system 300 each comprise a collection of circuitry that, when in combined operation, perform various operations of the server computing system 300 as described herein. In some embodiments, one or more components of the server computing system 300 are incorporated as or within one or more server computing systems to provide, as one non-limiting example, graphics rendering for display to one or more users via one or more remote client computing devices. It will be appreciated that such an associated client computing device may include some components of the server computing system 300, but not necessarily all of them. In a networked deployment, the server computing system 300 may operate in the capacity of a server machine, a client machine, or both in server-client network environments. In at least one example, the server computing system 300 may act as a peer system in peer-to-peer (P2P) (or other distributed) network environment. The server computing system 300 may therefore operate in certain embodiments as a server computer, a personal computer (PC), a tablet PC, a set-top box (STB), a mobile computing device, a web appliance, a network router, switch or bridge, or any system capable of executing instructions (sequential or otherwise) that specify actions to be taken by that system. Further, while only a single system is illustrated, the term “system” shall also be taken to include any collection of systems that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The server computing system 300 includes one or more hardware processors 302 (e.g., a central processing unit (CPU), a hardware processor core, or any combination thereof), a main memory 304, and a graphics processing unit (GPU) 306 or other parallel processor, some or all of which may communicate with each other via an interlink (e.g., bus) 308. In the depicted embodiment, a graphics driver 325 (which may be operationally analogous to GPU driver 119 of FIG. 1) is executing within the main memory 304, such as to interface with the GPU 306 to implement performance of various operations described herein.

The server computing system 300 further includes a display unit 310 (such as a display monitor or other display device), an input device 312 (e.g., a keyboard or other physical or touch-based actuators), and a user interface (UI) navigation device 314 (e.g., a mouse or other pointing device, such as a touch-based interface). In one example, the display unit 310, input device 312, and UI navigation device 314 may include a touch screen display. The server computing system 300 may additionally include a storage device (e.g., drive unit) 316, a signal generation device 318 (e.g., a speaker), a network interface device 320, and one or more sensors 321, such as a global positioning system (GPS) sensor, compass, accelerometer, or other sensor. The server computing system 300 may include an output controller 328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 316 may include a computer-readable medium 322 on which is stored one or more sets of data structures or instructions 324 (e.g., software) embodying or utilized by any one or more of the techniques or functions described herein. The instructions 324 may also reside, completely or at least partially, within the main memory 304, within GPU 306, or within the hardware processor 302 during execution thereof by the server computing system 300. In an example, one or any combination of the hardware processor 302, the main memory 304, the GPU 306, or the storage device 316 may constitute computer-readable media.

While the computer-readable medium 322 is illustrated as a single medium, the term “computer-readable medium” may include a single medium or multiple media (e.g., a centralized or distributed database, and/or associated caches and servers) configured to store the one or more instructions 324. Moreover, in certain embodiments and scenarios, the instructions 324 may include data, such as digital representations of one or more composited or otherwise generated frames for localized display by one or more client devices 399.

The term “computer-readable medium” may include any medium that is capable of storing, encoding, or carrying instructions for execution by the server computing system 300 and that cause the server computing system 300 to perform any one or more of the techniques of the present disclosure, or that is capable of storing, encoding or carrying data structures used by or associated with such instructions. Non-limiting computer-readable medium examples may include solid-state memories, and optical and magnetic media. In an example, a massed computer-readable medium includes a computer-readable medium with a plurality of particles having invariant (e.g., rest) mass. Accordingly, massed computer-readable media are not transitory propagating signals. Specific examples of massed computer-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 324 may further be transmitted or received over a communications network 326 using a transmission medium via the network interface device 320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi °, IEEE 802.16 family of standards known as WiMax®), IEEE 802.15.4 family of standards, peer-to-peer (P2P) networks, among others. In an example, the network interface device 320 may include one or more physical jacks (e.g., Ethernet, coaxial, or phone jacks) or one or more antennas to connect to the communications network 326. In an example, the network interface device 320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the server computing system 300, and includes digital or analog communications signals or other intangible medium to facilitate communication of such software.

In some embodiments, the apparatus and techniques described above are implemented in a system including one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, by a host virtual machine (VM) executing on a computing system, a notification from at least one guest VM that a rendered frame from one or more applications executing on the at least one guest VM is available for display;
responsive to receiving the notification, retrieving a rendered frame from the at least one guest VM; and
generating, by the host VM, a composited frame for display based at least in part on the rendered frame retrieved from the at least one guest VM.

2. The method of claim 1, wherein retrieving the rendered frame from the at least one guest VM includes retrieving the rendered frame by accessing a frame memory associated with a virtual function of the at least one guest VM.

3. The method of claim 1 comprising retrieving multiple rendered frames from multiple guest VMs, wherein generating the composited frame for display by the host VM comprises compositing at least a portion of two or more rendered frames of the multiple rendered frames for simultaneous display.

4. The method of claim 2 comprising retrieving multiple rendered frames from multiple guest VMs, wherein generating the composited frame for display by the host VM comprises selecting one rendered frame of the multiple rendered frames for display.

5. The method of claim 1, wherein the rendered frame from the at least one guest VM comprises output from multiple applications composited by the at least one guest VM.

6. The method of claim 1, further comprising providing the composited frame to a remote client device for local display by the remote client device.

7. The method of claim 1 wherein the host VM is associated with a first set of privileges that includes accessing a physical function of the computing system for displaying the composited frame, and wherein the at least one guest VM is associated with a set of privileges that does not include accessing the physical function.

8. The method of claim 1, wherein receiving the notification from the at least one guest VM comprises processing an interrupt caused by a write operation to one or more registers of the host VM.

9. The method of claim 8, wherein the write operation to the one or more registers is based at least in part on one or more modifications to a swap chain associated with the one or more applications executing on the at least one guest VM.

10. The method of claim 1, wherein the virtual function of the at least one guest VM is a virtual function of a virtualized physical display, and wherein retrieving the rendered frame from the at least one guest VM by accessing the associated frame memory is performed by the host VM via a physical function of the virtualized physical display.

11. A computing system, comprising:
one or more processors;
a non-transitory computer readable medium storing a set of executable instructions that, when executed, cause the one or more processors to:
receive, by a host virtual machine (VM) executing on the computing system, a notification from a guest VM that a rendered frame from one or more applications executing on the guest VM is available for display;
responsive to the notification, retrieve a rendered frame from the guest VM; and
generate, by the host VM, a composited frame for display based at least in part on the rendered frame retrieved from the guest VM.

12. The computing system of claim 11, wherein the guest VM is one of multiple guest VMs that are executing on the computing system and managed by the host VM, and wherein the host VM retrieves multiple rendered frames from the multiple guest VMs by accessing a respective frame memory associated with each of the multiple guest VMs.

13. The computing system of claim 12, wherein the composited frame includes at least a portion of two or more rendered frames of the multiple rendered frames for simultaneous display.

14. The computing system of claim 12 wherein to generate the composited frame for display by the host VM includes to select one rendered frame of the multiple rendered frames for display.

15. The computing system of claim 11, wherein the rendered frame from the guest VM comprises output from multiple applications composited by the guest VM.

16. The computing system of claim 11, wherein the host VM provides the composited frame to a remote client device for local display by the remote client device.

17. The computing system of claim 11 wherein the host VM is associated with a first set of privileges that includes access to a physical function of the computing system for displaying the composited frame, and wherein the guest VM is associated with a set of privileges that does not include access to the physical function.

18. The computing system of claim 11, wherein to receive the notification from the guest VM includes processing an interrupt caused by a write operation to one or more registers of the host VM.

19. The computing system of claim 18, wherein the write operation to the one or more registers is based at least in part on one or more modifications to a swap chain associated with the one or more applications executing on the guest VM.

20. A non-transitory computer readable medium embodying a set of executable instructions, the set of executable instructions to manipulate at least one processor to:
instantiate a host virtual machine (VM) and one or more guest VMs;
receive, by the host VM, a notification from one guest VM of the one or more guest VMs indicating that a rendered frame from one or more applications executing on the one guest VM is available for display;
retrieve, by the host VM and responsive to receiving the notification, a rendered frame from the guest VM by accessing a frame memory associated with a virtual function of the one guest VM; and
generate, by the host VM, a composited frame for display based at least in part on the rendered frame retrieved from the guest VM.
